(19) United States
(12) Patent Application Publication
(10) Pub. No.: US 2016/0088128 A1
(43) Pub. Date: Mar. 24, 2016

(54) HOUSING, ELECTRONIC DEVICE USING THE HOUSING, AND METHOD FOR MAKING THE HOUSING

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HSIN-PEI CHANG, New Taipei (TW); WEN-RONG CHEN, New Taipei (TW); HUANN-WU CHIANG, New Taipei (TW); YUNG-CHING HUANG, New Taipei (TW); YANG-JIA LIU, Shenzhen (CN); BIN LI, Shenzhen (CN); HOU-RONG ZHUANG, Shenzhen (CN)

(21) Appl. No.: 14/559,610

(22) Filed: Dec. 3, 2014

(30) Foreign Application Priority Data
Sep. 22, 2014 (CN) 201410484562.8

(51) Int. Cl. H04M 1/02; B29C 45/00; B32B 3/30; B32B 37/12; B32B 9/04; B32B 7/12

(52) U.S. Cl. CPC H04M 1/0202; B32B 9/04; B32B 7/12; B32B 3/30; B32B 37/12; B29C 45/00; B32B 2457/00; B32B 2255/205; B32B 2451/00; B29K 2101/00

(57) ABSTRACT

A housing includes a ceramic layer for decoration, an intermediate layer formed on at least one surface of the ceramic layer, and a substrate coupled on the intermediate layer. The surface of the intermediate layer coupled to the substrate is rough and/or porous for improving the bonding of the substrate to the intermediate layer.

### FIELD

The subject matter herein generally relates to a housing, an electronic device using the housing, and a method for making the housing.

### BACKGROUND

Many people use portable electronic devices such as mobile phones and personal digital assistants (PDAs). Housings of the portable electronic devices may include metal/plastic substrates and ceramic patterns formed on the metal/plastic substrates for decoration. There is a need to combine metal/plastic and ceramic.

### BRIEF DESCRIPTION OF THE DRAWINGS

Implementations of the present technology will now be described, by way of example only, with reference to the attached figures.

FIG. 1 is a cross-sectional view of a first exemplary embodiment of a housing.

FIG. 2 is a cross-sectional view of a second exemplary embodiment of a housing.

FIG. 3 is an isometric view of an electronic device using the housing of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

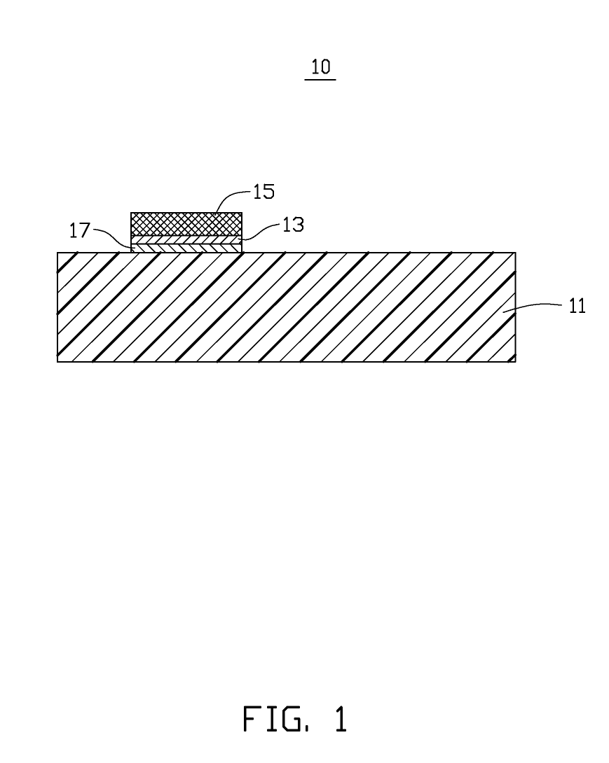

FIG. 1 illustrates a housing 10 according to a first exemplary embodiment. The housing 10 includes a ceramic layer 15, an intermediate layer 13 formed on at least one surface of the ceramic layer 15, and a substrate 11 coupled to the intermediate layer 13.

In this embodiment, the intermediate layer 13 and the ceramic layer 15 protrude from the surface of the substrate 11. The intermediate layer 13 completely covers the at least one surface of the ceramic layer 15, and partially covers one surface of the substrate 11.

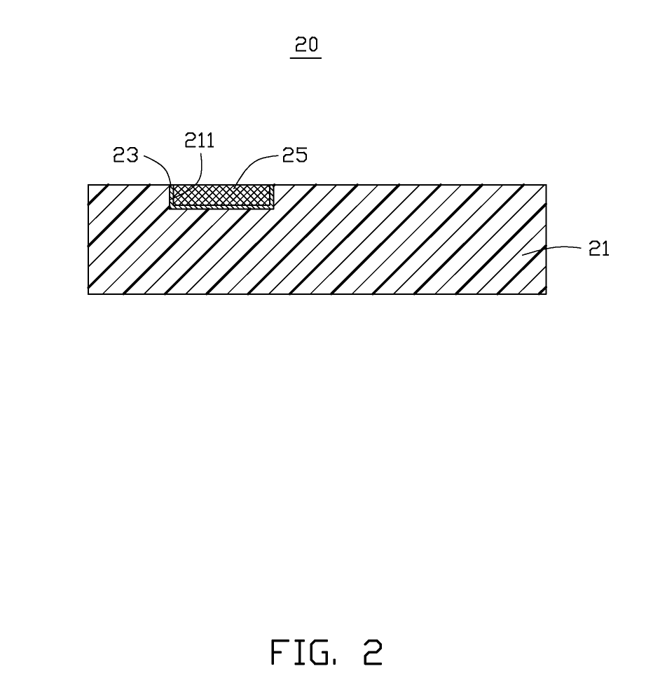

FIG. 2 illustrates a housing 20 according to a second exemplary embodiment. The housing 20 includes a substrate 21, a ceramic layer 25, and an intermediate layer 23 formed between the substrate 21 and the ceramic layer 25. The substrate 21 defines a groove 211 receiving the ceramic layer 25. The intermediate layer 23 is located between the wall of the groove 211 and the ceramic layer 25. The intermediate layer 23 covers three surfaces of the ceramic layer 25.

The ceramic layers 15, 25 define a pattern or a Logo to decorate the housing 10, 20. The ceramic layers 15, 25 can be made of any ceramic materials known in the field. The ceramic layers 15, 25 have a thickness of about 0.2 mm to about 5 mm.

The surface of the intermediate layer 13 bonding the substrate 11 and the surface of the intermediate layer 23 bonding the substrate 21 have a surface roughness Ra of about 0.1 μm to about 10 μm. That is, the surface of the intermediate layers 13 bonding the substrate 11 and the surface of the intermediate layers 23 bonding the substrate 21 are rough and/or porous, which benefits the bonding of the substrate 11 to the intermediate layers 13 and the bonding of the substrate 21 to the intermediate layers 23.

The intermediate layers 13, 23 are preferably made of metal selected such as by way of non-limiting example titanium, titanium-tungsten alloy, titanium-copper alloy, nickel, nickel-chromium alloy, nickel-tungsten alloy, aluminum, silver, gold, palladium, copper, and any combination thereof. The intermediate layers 13, 23 have a thickness of about 0.05 μm to about 20 μm. The substrates 11, 21 can be made of plastic or metal. As shown in FIG. 1, when the substrate 11 is made of metal, an adhesive layer 17 can be formed between the intermediate layer 13 and the substrate 11 to improve the bonding between the intermediate layer 13 and the substrate 11. As shown in FIG. 2, when the substrate 21 is made of plastic, the substrate 21 can be directly coupled to and bonds the surface of the intermediate layer 23 by injection molding, for example.

The ceramic layers 15, 25 may be white or any color. A glaze layer (not shown) or a colored layer (not shown) may be formed on the surface of the ceramic layer 15 or the ceramic layer 25 to further decorate the housings 10, 20. The surface of the ceramic layer 15 exposed to the substrate 11 or the surface of the ceramic layer 25 exposed to the substrate 21 can be polished to create a mirror effect.

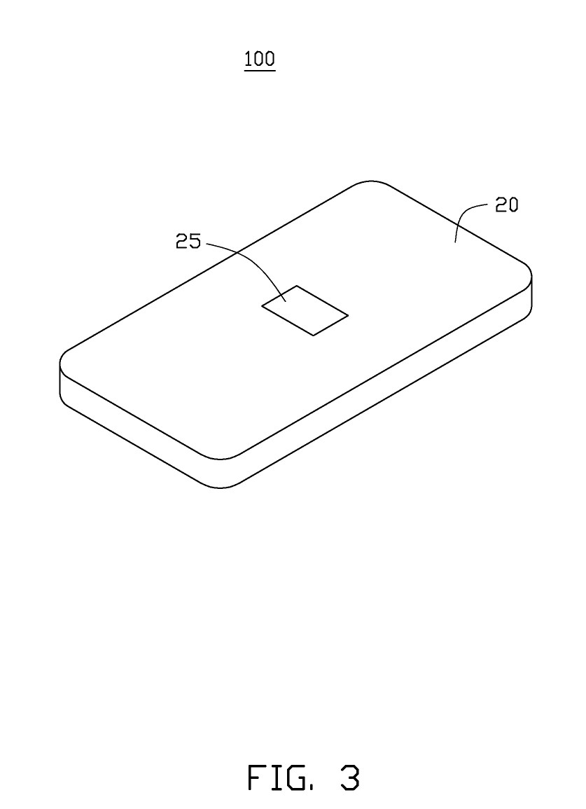

FIG. 3 illustrates the above-described housing 20 being used in an electronic device 100. In this embodiment, the housing 20 is used as a rear cover of the electronic device 100. The electronic device 100 can be any conventional electronic device, such as mobile phone or tablet computer. The electronic device 100 also includes other elements (not shown), such as display screen, motherboard, and power source, etc.

A method for making a housing may include the following steps:

First, a ceramic layer is provided. The ceramic layer defines a pattern or a Logo. The ceramic layer has a thickness of about 0.2 mm to about 5 mm.

Then, an intermediate layer is formed on at least one surface of the ceramic layer, preferably at least the surface facing the substrate 11. The intermediate layer can be formed by any known methods in the field, such as chemical vapor deposition, sputtering deposition, evaporation deposition, or printing and sintering, etc. The intermediate layer is made of metal selected from a group consisting of titanium, titanium-tungsten alloy, titanium-copper alloy, nickel, nickel-chromium alloy, nickel-tungsten alloy, aluminum, silver, gold, palladium, copper, and any combination thereof. The intermediate layer has a thickness of about 0.05 μm to about 20 μm.

The surface of the intermediate layer facing away from the ceramic layer is rough and/or porous, which is benefit for the bonding of a substrate to the intermediate layer. The rough and/or porous surface of the intermediate layer can be directly formed during the deposition process of the intermediate layer. Or the rough and/or porous surface of the intermediate layer can be formed by roughening after the intermediate layer is formed. The roughening method can be any known roughening methods in the field, such as etching.

Next, a substrate is coupled to the rough and/or porous surface of the intermediate layer. When the substrate is a plastic substrate, the substrate can be formed by injecting molten plastic to the intermediate layer. When the substrate is a metal substrate, the metal substrate can be coupled to the intermediate layer using an adhesive layer.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiments of the disclosure.

1. A housing, comprising:
a ceramic layer;
an intermediate layer formed on and in directly contact with at least one surface of the ceramic layer, the intermediate layer being made of one selected from a group consisting of titanium, titanium-tungsten alloy, titanium-copper alloy, nickel, nickel-chromium alloy, nickel-tungsten alloy, aluminum, silver, gold, palladium, copper, a surface of the intermediate layer facing away from the ceramic layer being rough; and
a substrate coupled to the rough surface of the intermediate layer.

2. The housing as claimed in claim 1, wherein the rough surface of the intermediate layer has a surface roughness Ra of about 0.1 μm to about 10 μm.

3. (canceled)

4. The housing as claimed in claim 1, wherein the intermediate layer has a thickness of about 0.05 μm to about 20 μm.

5. The housing as claimed in claim 1, wherein the ceramic layer defines a pattern, the ceramic layer has a thickness of about 0.2 mm to about 5 mm.

6. The housing as claimed in claim 1, wherein the substrate is made of plastic or metal.

7. The housing as claimed in claim 6, wherein the substrate is made of metal, an adhesive layer is formed between the intermediate layer and the substrate.

8. The housing as claimed in claim 1, wherein the substrate defines a groove receiving the ceramic layer and the intermediate layer.

9. A method for making a housing, comprising:
providing a ceramic layer;
forming an intermediate layer on and in directly contact with at least one surface of the ceramic layer, the intermediate layer being made of one selected from a group consisting of titanium, titanium-tungsten alloy, titanium-copper alloy, nickel, nickel-chromium alloy, nickel-tungsten alloy, aluminum, silver, gold, palladium, copper, a surface of the intermediate layer facing away from the ceramic layer being rough; and
coupling a substrate to the rough and/or porous surface of the intermediate layer.

10. The method as claimed in claim 9, wherein the intermediate layer has a thickness of about 0.05 μm to about 20 μm.

11. The method as claimed in claim 10, wherein the intermediate layer is formed by chemical vapor deposition, sputtering deposition, evaporation deposition, or printing and sintering.

12. The method as claimed in claim 9, wherein the ceramic layer defines a pattern, and the ceramic layer has a thickness of about 0.2 mm to about 5 mm.

13. The method as claimed in claim 9, wherein when the substrate is made of plastic, the substrate is formed by injection molding.

14. The method as claimed in claim 9, wherein when the substrate is made of metal, the method further comprises a step of forming an adhesive layer on the intermediate layer before coupling the substrate to the rough and/or porous surface of the intermediate layer.

15. An electronic device, comprising:
a housing, comprising:
a ceramic layer;
an intermediate layer formed on and in directly contact with at least one surface of the ceramic layer, the intermediate layer being made of one selected from a group consisting of titanium, titanium-tungsten alloy, titanium-copper alloy, nickel, nickel-chromium alloy, nickel-tungsten alloy, aluminum, silver, gold, palladium, copper, a surface of the intermediate layer by facing away from the ceramic layer being rough; and
a substrate coupled to the rough surface of the intermediate layer.

16. The electronic device as claimed in claim 15, wherein the rough surface of the intermediate layer has a surface roughness Ra of about 0.1 μm to about 10 μm.

17. The electronic device as claimed in claim 15, wherein the intermediate layer has a thickness of about 0.05 μm to about 20 μm.

18. The electronic device as claimed in claim 15, wherein the ceramic layer defines a pattern, the ceramic layer has a thickness of about 0.2 mm to about 5 mm.

19. The electronic device as claimed in claim 15, wherein the substrate is made of plastic or metal.

20. The electronic device as claimed in claim 19, wherein the substrate is made of metal, and the substrate is coupled to the intermediate layer by an adhesive layer.
